(19) United States
(12) Patent Application Publication
(10) Pub. No.: US 2016/0125631 A1
(43) Pub. Date: May 5, 2016

(54) APPARATUS FOR DYNAMICALLY CONTROLLING HUD (HEAD-UP DISPLAY) INFORMATION DISPLAY POSITION

(71) Applicant: TINNOS INC., Seoul (KR)

(72) Inventor: Seong Sik HAM, Seoul (KR)

(21) Appl. No.: 14/707,520

(22) Filed: May 8, 2015

(30) Foreign Application Priority Data
Oct. 31, 2014 (KR) 10-2014-0149943
Apr. 3, 2015 (JP) 2015-076592

(51) Int. Cl. G06T 11/60; G06T 7/00

(52) U.S. Cl. CPC G06T 11/60; G06T 7/0042; G06T 2207/30201; G06T 2207/30252

(57) ABSTRACT

An apparatus for controlling an HUD-information display position includes an outside-information generating unit that captures outside image of a vehicle and generates information on a surrounding of the vehicle from a captured image, an HUD-information generating unit that generates HUD information including vehicle operation information based on the information on the surrounding of the vehicle, an HUD-information projection unit that projects light corresponding to the HUD information to display the HUD information at a predetermined position on an inner side of a windshield, an HUD-information-display-position adjustment unit including a movable mechanism for moving the HUD-information projection unit to adjust the HUD-information display position, an HUD-information-display-position determining unit that determines the HUD-information display position based on the information on the surrounding of the vehicle, and a control unit that dynamically controls the HUD-information-display-position adjustment unit to display the HUD information at the HUD-information display position determined by the HUD-information-display-position determining unit.

### CROSS-REFERENCE TO RELATED APPLICATIONS

This application claims the benefit of Korean Patent Application No. 10-2014-0149943 filed with the Korean Intellectual Property Office on Oct. 31, 2014 and Japanese Patent Application No. 2015-076592 filed with the Japanese Patent Office on Apr. 3, 2015, the full disclosure of which is incorporated herein by reference.

### BACKGROUND

1. Field

The present disclosure relates to an apparatus for dynamically controlling an HUD (Head-Up Display) information display position, and more particularly, to an apparatus for dynamically controlling an HUD-information display position such that HUD information is constantly displayed at an optimal position to be easily recognized by a driver when driving a vehicle.

2. Description of the Related Art

Recently, HUD device has been applied to a motor vehicle so as provide effectively vehicle driving information and peripheral status information and the like to a driver during operation.

However, since such a conventional vehicle HUD device displays a navigation information including the vehicle driving information and the peripheral status information at a specific position fixed on the front glass of the vehicle, there is a case where displayed HUD information is difficult to be recognized by the driver due to the horizon of the road in front, an intersection or positions of other vehicles.

Korean Patent No. 1343175 discloses “a method and apparatus for displaying HUD display data” wherein HUD data is transferred to HUD device in wireless to display the data on the front glass of a vehicle.

However, in such a conventional HUD device, since the HUD information is displayed on a fixed position without considering an intersection, the horizon of the road looking at the front, etc. for operation, there is a problem that the displayed HUD information cannot be easily recognized by a driver due to the front view of a vehicle.

### SUMMARY

An apparatus for controlling an HUD (Head-Up Display) information display position, according to some embodiments of the present disclosure, includes an outside-information generating unit configured to capture an outside image of a vehicle and to generate information on a surrounding of the vehicle from a captured image, an HUD-information generating unit configured to generate HUD information including vehicle operation information for driving the vehicle based on the information on the surrounding of the vehicle, an HUD-information projection unit configured to project light corresponding to the HUD information to display the HUD information at a predetermined position on an inner side of a windshield of the vehicle, an HUD-information-display-position adjustment unit including a movable mechanism for moving the HUD-information projection unit to adjust the HUD-information display position, an HUD-information-display-position determining unit configured to determine the HUD-information display position based on the information on the surrounding of the vehicle, and a control unit configured to dynamically control the HUD-information-display-position adjustment unit to display the HUD information at the HUD-information display position determined by the HUD-information-display-position determining unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram showing a form in which HUD information is displayed on the front glass of a vehicle in an embodiment of the present disclosure;

FIG. 2 is a functional block diagram of a HUD-information display position control apparatus according to an embodiment of the present disclosure;

FIG. 3 is a schematic diagram showing a change of HUD-information display position in an HUD-information display position control apparatus according to an embodiment of the present disclosure;

FIG. 4 is a schematic diagram showing information displayed by an HUD-information display position control apparatus according to an embodiment of the present disclosure; and

FIG. 5 is a schematic diagram showing a form in which the display position of HUD information is determined depending on the position of driver pupils in an embodiment of the present disclosure.

### DETAILED DESCRIPTION OF THE PREFERRED EMBODIMENTS

Exemplary embodiments of the present disclosure are described in detail below with reference to the accompanying drawings. In the following descriptions, like reference numerals designate like elements although the elements are shown in different drawings. Further, detailed descriptions of known functions and configurations incorporated herein are omitted for the purpose of clarity and for brevity.

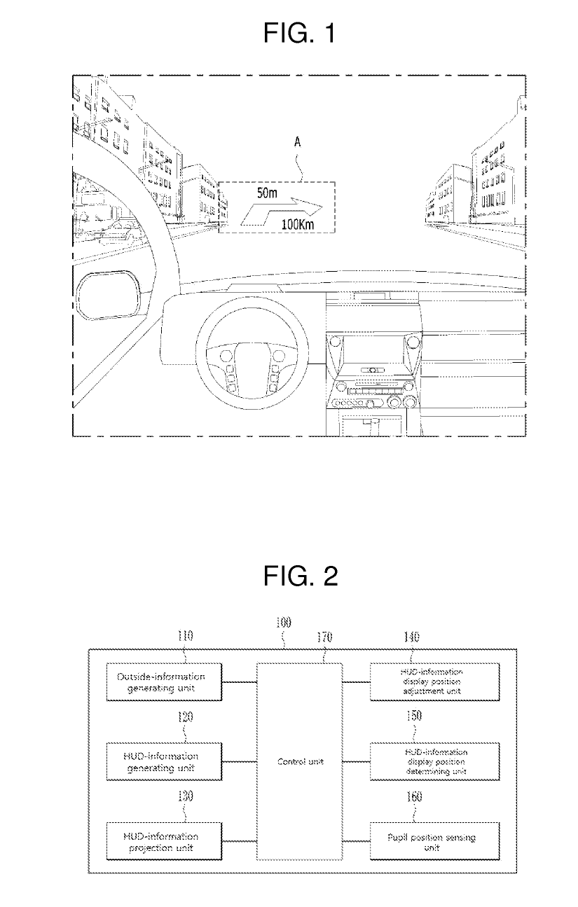

FIG. 1 is a schematic diagram showing a form in which HUD information is displayed on the front glass of a vehicle in an embodiment of the present disclosure. FIG. 2 is a functional block diagram of a HUD-information display position control apparatus 100 according to an embodiment of the present disclosure.

According to an embodiment of the present disclosure, a HUD-information display position control apparatus 100 displays HUD information at an optimal position to be easily recognized by a driver on the front glass of a motor vehicle.

In FIG. 1, HUD information and a position at which the HUD information is displayed are represented by “A”.

In conventional HUD device, HUD information is displayed at a predetermined position that is fixed. Therefore, a driver is required to move his eyes to the position at which the HUD information is displayed in order to check the HUD information during operation. Further, there is a case in which it is difficult to recognize the HUD information due to the front views of a vehicle.

To solve these problems, according to an embodiment of the present disclosure, a HUD-information display position control apparatus 100 considers front view information of a vehicle and a time zone, determines an optimal position at which HUD information is easy recognized by a driver, and controls to display the HUD information at the optimal position.

Here, the vehicle front view information includes at least any one of something that are viewed in front of a vehicle during operation (building, trees, pedestrians, etc.), the horizon of a road, an intersection and other vehicles in front of the vehicle.

When HUD information is displayed on the front glass of a vehicle, there is a case in which it is difficult for a driver to recognize the HUD information due to a position of the horizon of a road, the situation of an intersection, pedestrians, positions of other vehicles in front of the vehicle and the like. In this case, according to an embodiment of the present disclosure, a HUD-information display position control apparatus 100 analyzes front view information of the vehicle to be able to display the HUD information at a position easily recognized by the driver during operation.

In HUD information displayed on the front glass of a vehicle, an identifiable degree for the HUD information may be changed due to the external brightness of the vehicle. In daytime when the outside of the vehicle is bright, by displaying more brightly the HUD information, it can be more easily recognized by a driver of the vehicle. Meanwhile, at night when the outside of the vehicle is dark, there is no problem for the driver to recognize the HUD information even if the HUD information is displayed darker than the daytime.

According to an embodiment of the present disclosure, a HUD-information display position control apparatus 100 adjusts the brightness to display the HUD information depending on the external brightness of the vehicle by analyzing the external brightness of the vehicle and time zone, and control to display the HUD information in optimal conditions so that the driver can easily recognize.

FIG. 2 is a functional block diagram of a HUD-information display position control apparatus 100 according to an embodiment of the present disclosure.

According to an embodiment of the present disclosure, a HUD-information display position control apparatus 100 comprises an external information generating unit 110, a HUD-information generating unit 120, a HUD-information projection unit 130, a HUD-information-display-position adjustment unit 140, a HUD-information-display-position determining unit 150, a pupil position sensing unit 160 and control unit 170.

The external information generating unit 110 photographs outside images of a vehicle and generates information on vehicle surroundings. The vehicle surrounding information includes vehicle front view information in front of a vehicle and vehicle rear view information in rear of the vehicle.

To this end, the external information generating unit 110 comprises a front camera for generating front images of the vehicle which is located at the front of the vehicle and a rear camera for generating rear images of the vehicle which is located at the rear of the vehicle.

The HUD-information generating unit 120 generates HUD information including vehicle operation information necessary for operation of the vehicle based on the vehicle surrounding information generated by the external information generating unit 110.

Here, the HUD information includes vehicle operation information, navigation information and a warning message due to the vehicle surrounding information.

The HUD-information projection unit 130 comprises a device (for example, a beam projector) capable of projecting light (specifically, the light of carrying the HUD information) corresponding to the HUD information and projects light corresponding to the HUD information generated by the HUD-information generating unit 120 to the front glass of the vehicle to display the HUD information at a predetermined position of the front glass of the vehicle.

The HUD-information-display-position adjustment unit 140 comprises a movable mechanism for moving the HUD-information projection unit 130 (for example, rotational, horizontal and vertical movement, etc.) to adjust a position of displaying the HUD information at the front glass of the vehicle.

The HUD-information-display-position determining unit 150 determines the position of displaying the HUD information.

The HUD-information-display-position determining unit 150 determines the position of displaying the HUD information based on the vehicle front view information of the vehicle surrounding information from the external information generating unit 110.

That is, the HUD-information-display-position determining unit 150 takes into account objects (such as buildings, trees, etc.) that are located in front of the vehicle, the horizon of a road, an intersection, a position of a pedestrian, etc. included in the vehicle front view information to determine the position to be displayed at which a driver can more easily recognize the HUD information.

For example, since there is a possibility that the recognition rate of the HUD information is lowered when the HUD information is displayed at a position higher than the horizon of the road, the HUD information should be displayed at a position lower than the horizon of the road. Further, since there is a possibility that the recognition rate of the HUD information is lowered also when the displayed HUD information overlaps with an object located in front of the vehicle, the HUD information should be displayed so as not to overlap with the object located in front of the vehicle.

The pupil position sensing unit 160 senses the position of the driver's pupils. To this end, the pupil position sensing unit 160 is mounted on a position capable of easily sensing the position of the driver's pupils. For example, the pupil position sensing unit 160 is mounted on the room mirror at the top of the front glass of the vehicle.

The control unit 170 controls the HUD-information-display-position adjustment unit 140 to display the HUD information at the HUD-information display position determined by the HUD-information-display-position determining unit 150

The control unit 170 further takes into account a position of the driver's pupils sensed by the pupil position sensing unit 160 and control the HUD-information-display-position adjustment unit 140 to display the HUD information at a position easily recognized by the driver.

Further, the control unit 170 adjusts the intensity of light to be projected by the HUD-information projection unit 130 depending on the external brightness of the vehicle and controls that the HUD information is clearly displayed on the front glass of the vehicle.

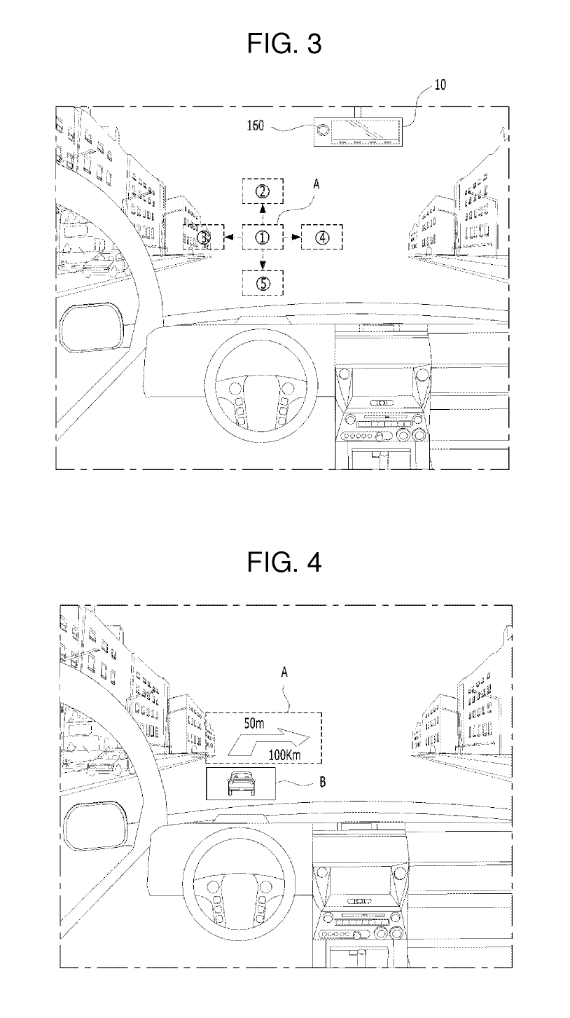

FIG. 3 is a schematic diagram showing a change of HUD-information display position by a HUD-information display position control apparatus according to an embodiment of the present disclosure.

As mentioned above, according to an embodiment of the present disclosure, the HUD-information display position control apparatus 100 is capable of displaying the HUD information at a position on the front glass of the vehicle that is easily recognized by a driver.

That is, the position of display area (A) of the HUD information is capable of being moved from the initial position (1) toward upper part (2), left part (3), right part (4), lower part (5), or various other directions to be easily recognized by a driver.

FIG. 4 is a schematic diagram showing information displayed by a HUD-information display position control apparatus according to an embodiment of the present disclosure.

In general, HUD information includes vehicle operation information and navigation information.

However, in an embodiment of the present disclosure, HUD information includes rear information generated by a rear camera in addition to the vehicle operation information and the navigation information.

In FIG. 4, an area (A) represents HUD information including the vehicle operation information and navigation information, and an area (B) represents HUD information including the rear information generated by a rear camera (images photographed by a rear camera).

In an embodiment of the present disclosure, since the HUD information is provided with the rear information of a vehicle generated by the rear camera, a driver can recognize blind spot information in rear of the vehicle which is not recognized by room mirror and side mirror.

In an embodiment of the present disclosure, the area (A) and the area (B) are not fixed at specific positions, and are capable of being dynamically moved to an optimal position easily recognized by a driver

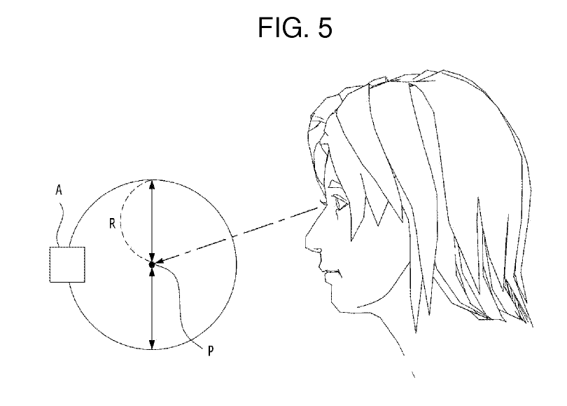

FIG. 5 is a schematic diagram showing a form in which the display position of HUD information is determined depending on the position of driver pupils according to an embodiment of the present disclosure.

As mentioned above, according to an embodiment of the present disclosure, the HUD-information display position control apparatus 100 is capable of adjusting the HUD-information display position by further considering the position of the driver's pupils.

In an embodiment of the present disclosure, the control unit 170 determines the direction of the driver's line of sight by analyzing the position of the driver's pupils sensed by the pupil position sensing unit 160. Then, the control unit 170 controls to display HUD information at a predetermined distance (R) in the redial direction from the center (P) of the driver's line of sight on the inner surface of the front glass of a vehicle. In an embodiment of the present disclosure, the predetermined distance (R) from the center (P) of the driver's line of sight is a distance which is greater than or equal to first distance and less than or equal to second distance in redial direction. Specifically, the distance (R) is within the range of 10 cm to 30 cm.

Here, the reason why it is controlled that the HUD information is positioned at the predetermined distance (R) from the center (P) of the driver's line of sight is as follows.

When the HUD information is displayed at the center (P) of the driver's line of sight, the driver may not be concentrated in vehicle front view information. Conversely, when the HUD information is too far from the center (P) of the driver's line of sight, it diverts the driver's line of sight to conform the HUD information during operation.

Therefore, in an embodiment of the present disclosure, the HUD information is displayed at a remote position from the driver's line of sight by a predetermined distance (preferably, 10 cm to 30 cm), and the driver can recognize the field of front view and the HUD information at the same time. In this case, since the driver can easily recognize information necessary for operation while looking at the front, he can prevent the risk of diverting the line of sight from the front for operation.

The present disclosure is to solve the problems of the conventional techniques such as those described above. Therefore, the present disclosure provides a HUD-information display position control apparatus for dynamically controlling a HUD-information display position based on information about the status of the road in front of a vehicle and displaying the HUD information to an optimal position where a driver can easily recognize.

According to the present disclosure, there is an effect that a driver can easily recognize HUD information by recognizing road conditions to display HUD information at an optimal position of the front glass of a vehicle.

The present disclosure should not be limited to these embodiments but various changes and modifications are made by one ordinarily skilled in the art within the subject matter, the spirit and scope of the present disclosure as hereinafter claimed. Specific terms used in this disclosure and drawings are used for illustrative purposes and not to be considered as limitations of the present disclosure. Exemplary embodiments of the present disclosure have been described for the sake of brevity and clarity. Accordingly, one of ordinary skill would understand the scope of the claimed invention is not to be limited by the explicitly described above embodiments but by the claims and equivalents thereof.

1. An apparatus for controlling a head-up display (HUD) information display position, the apparatus comprising:
an outside-information generating unit configured
to capture an outside image of a vehicle, and
to generate information on a surrounding of the vehicle from a captured image, the information on the surrounding of the vehicle including information on a horizon of a road ahead of the vehicle;
an HUD-information generating unit configured to generate HUD information including vehicle operation information for driving the vehicle based on the information on the surrounding of the vehicle;
an HUD-information projection unit configured to project light corresponding to the HUD information to display the information at a predetermined position on an inner side of a windshield of the vehicle;
an HUD-information-display-position adjustment unit including a movable mechanism for moving the HUD-information projection unit to adjust the HUD-information display position;
an HUD-information-display-position determining unit configured to determine the HUD-information display position based on the information on the surrounding of the vehicle; and
a control unit configured to dynamically control the HUD-information-display-position adjustment unit to display the HUD information at the HUD-information display position determined by the HUD-information-display-position determining unit, wherein
the HUD-information-display-position determining unit is configured to determine the HUD-information-display-position at an area below the horizon of the road based on the information on the horizon of the road ahead of the vehicle, and
the control unit is configured to dynamically control the HUD-information-display-position adjustment unit to display the HUD information at the HUD-information-display-position at the area below the horizon of the road determined by the HUD-information-display-position determining unit.

2. (canceled)

3. The apparatus according to claim 1, wherein the HUD-information-display-position determining unit is configured to determine a position where the HUD information overlaps with no object in front of the vehicle specified by the information on the surrounding of the vehicle, as the HUD-information display position.

4. The apparatus according to claim 3, wherein
the information on the surrounding of the vehicle further includes information on an intersection and a vehicle in front of the vehicle while driving the vehicle, and
the HUD-information-display-position determining unit is configured to determine the HUD-information-display-position further based on the information on the intersection and the vehicle in front of the vehicle.

5. The apparatus according to claim 3, further comprising a pupil position sensing unit configured to sense a position of a pupil of a driver of the vehicle, wherein
the HUD-information-display-position determining unit is configured to determine the HUD-information display position further based on the position of the pupil of the driver.

6. The apparatus according to claim 1, wherein the control unit is configured to control a brightness of the light when projecting the HUD information depending on a brightness outside the vehicle.

7. The apparatus according to claim 1, wherein
the outside-information generating unit includes
a front camera configured to capture a front-side image of the vehicle, and
a rear camera configured to capture a rear-side image of the vehicle,
the front-side image includes front-side information of the vehicle,
the rear-side image includes blind spot information and rear-side information of the vehicle, and
the HUD information further includes the blind spot information and the rear-side information.

8. The apparatus according to claim 5, wherein the HUD-information-display-position determining unit is configured
to calculate a driver's line of sight based on the position of the pupil of the driver, and
to determine the HUD-information display position at a position within an area which is equal to or greater than a first distance and equal to or less than a second distance in a radial direction from a center of the driver's line of sight.

9. The apparatus according to claim 8, wherein
the first distance is 10 centimeters, and
the second distance is 30 centimeters.

10. A method of controlling a head-up display (HUD) information display position, the method comprising:
capturing an outside image of a vehicle with an outside-information generating unit;
generating information on a surrounding of the vehicle from a captured image, the information on the surrounding of the vehicle including information on a horizon of a road ahead of the vehicle;
generating HUD information including vehicle operation information for driving the vehicle based on the information on the surrounding of the vehicle;
projecting light corresponding to the HUD information to display HUD information at a predetermined position on an inner side of a windshield of the vehicle;
determining the HUD-information display position based on the information on the surrounding of the vehicle; and
controlling dynamically the projecting to display the HUD information at the HUD-information display position determined at the determining, wherein
the determining includes determining the HUD-information-display-position at an area below the horizon of the road based on the information on the horizon of the road ahead of the vehicle, and
the controlling includes dynamically controlling the projecting to display the HUD information at the HUD-information-display-position at the area below the horizon of the road determined at the determining.

11. The method according to claim 10, wherein the determining further includes determining a position where the HUD information overlaps with no object in front of the vehicle specified by the information on the surrounding of the vehicle, as the HUD-information display position.

12. The method according to claim 11, wherein
the information on the surrounding of the vehicle further includes information on an intersection and a vehicle in front of the vehicle while driving the vehicle, and
the determining further includes determining the HUD-information-display-position further based on the information on the intersection and the vehicle in front of the vehicle.

13. The method according to claim 11, further comprising sensing a position of a pupil of a driver of the vehicle with a pupil position sensing unit, wherein
the determining unit further includes determining the HUD-information display position further based on the position of the pupil of the driver.

14. The method according to claim 10, wherein the controlling further includes controlling a brightness of the light when projecting the HUD information depending on a brightness outside the vehicle.

15. The method according to claim 10, wherein
the outside-information generating unit includes
a front camera configured to capture a front-side image of the vehicle, and
a rear camera configured to capture a rear-side image of the vehicle,
the front-side image includes front-side information of the vehicle,
the rear-side image includes blind spot information and rear-side information of the vehicle, and
the HUD information further includes the blind spot information and the rear-side information.

16. The method according to claim 13, wherein the determining further includes
calculating a driver's line of sight based on the position of the pupil of the driver, and
determining the HUD-information display position at a position within an area which is equal to or greater than a first distance and equal to or less than a second distance in a radial direction from a center of the driver's line of sight.

17. The method according to claim 16, wherein
the first distance is 10 centimeters, and
the second distance is 30 centimeters.
